(19) United States
(12) Patent Application Publication
(10) Pub. No.: US 2001/0049791 A1
(43) Pub. Date: Dec. 6, 2001

(54) Security process of a communication for passive entry and start system

(76) Inventor: Alain Gascher, Paris (FR)

Correspondence Address: Liniak, Berenato, Longacre & White, Suite 240, 6550 Rock Spring Drive, Bethesda, MD, 20817, US

(21) Appl. No.: 09/836,438

(22) Filed: Jun. 20, 2001

(30) Foreign Application Priority Data
Apr. 18, 2000 (FR) 0004990

(51) Int. Cl. H04L 9/32

(52) U.S. Cl. 713/185; 713/168

(57) ABSTRACT

The process for securing a communication between a recognition device and an identification unit able to communicate with the recognition device by a data exchange determined by a recognition protocol, one of these items of data corresponding to a reference event, the process communicating in such a way that the recognition device can authenticate the identification unit so as to instruct the unlocking of openable panels of a vehicle and/or permit the starting of a vehicle and furthermore comprising:

after an initialization time defined with respect to the reference event of the recognition protocol, a step of transmission by the recognition device of at least two transmission data,

a step of transmission by the identification unit of at least two response data in response to the transmission data,

a step of measuring a reaction time between the transmission of a data item and the reception of a corresponding response data item by the recognition device, and a step of verifying that the measured reaction time is less than a predetermined threshold

wherein the time interval between the transmission of two successive transmission data and/or the initialization time are/is made to vary randomly.

The invention pertains to a process for securing a communication between a recognition device and an identification unit able to communicate with the recognition device in such a way that the recognition device can authenticate the identification unit so as to instruct the unlocking of openable panels of a vehicle and/or permit the starting of a vehicle.

Such a recognition device together with an identification unit constitutes a so-called <<hands-free>> access system. In such an access system, the recognition device transmits a signal consisting of data to a certain distance around the vehicle. When the user carrying the identification unit is located within the field of transmission of the signal, he transmits response data. If these response data are recognized by the recognition device, it instructs the unlocking of openable panels of the vehicle and/or permits the starting of the vehicle.

Thus, the user can unlock the openable panels of his vehicle without having to manipulate any key or remote control: the simple fact of carrying or wearing an identification unit, which may be a badge, allows him to see his vehicle be unlocked.

FIG. 1 represents an example of an exchange of data between a recognition device and an identification unit. This exchange of data is generally referred to as a recognition protocol. It follows a predetermined sequence consisting for example of an authentication phase AUT and of an antipirating phase ANP. The authentication phase AUT comprises a step of initialization or wakeup step RE, a request step RQ, an anticollision step ANC, a selection step SE and possibly a response step RP. The antipirating phase comprises steps of transmitting transmission data P1 and of receiving response data P1R. The response step RP may possibly be combined with the antipirating phase ANP.

In such a system, the two-way communication in the form of an exchange of data between the recognition device and the identification unit is generally aimed at enabling the recognition device to authenticate the identification unit, on the one hand by verifying its signature and on the other hand by evaluating a reaction time in the exchange of data.

The objective of evaluating a reaction time is to detect pirating by repeater: if a first pirate, furnished with a first transmitter/receiver relay, located in proximity to the vehicle, is in touch with a second pirate, furnished with a second transmitter/receiver relay located in proximity to the bearer of the identification unit, the two pirates are able to trigger an exchange of data between the recognition device and the identification unit, unbeknown to the bearer of the identification unit.

This being so, the repeater thus constructed necessarily increases the reaction time in the exchange of data between a recognition device and the identification unit. By evaluating a reaction time, a recognition device can therefore detect pirating by repeater, and thus not instruct the unlocking of the openable panels of the vehicle. A recognition device of this type is known in particular through the document DE 198 02 526.

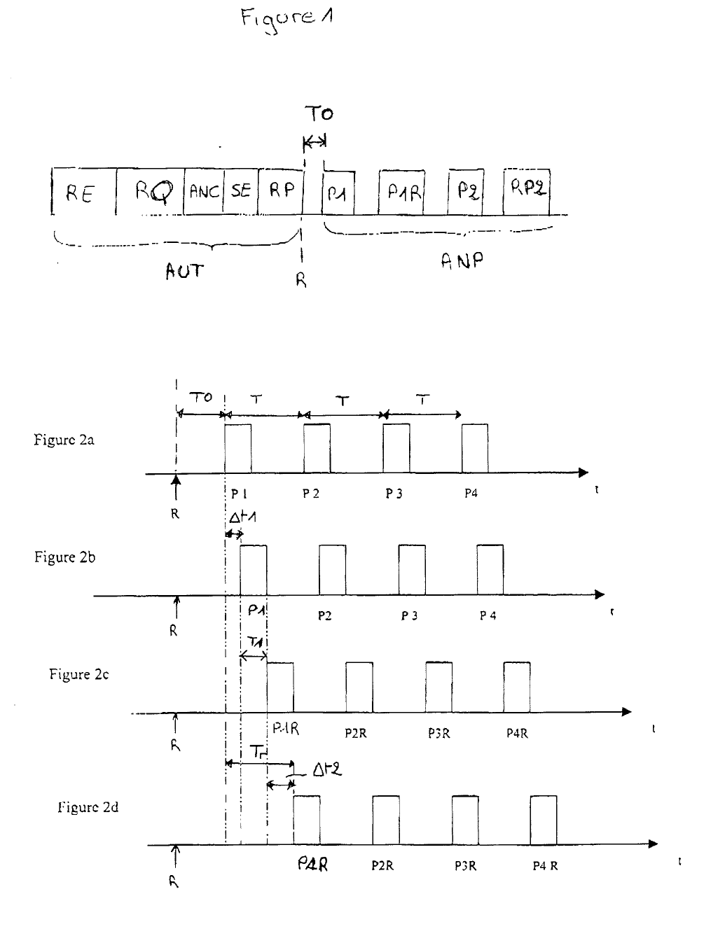

FIGS. 2a to 2d are graphical representations of an exchange of data between a recognition device such as that disclosed in the document DE 198 02 526 and an identification unit in the presence of a pirate relay.

In particular, FIG. 2a represents versus time the data transmitted by the recognition device.

The expression <<reference event R>> refers to any event of the recognition protocol identifiable as a cue by a pirate relay.

The recognition device transmits a transmission datum P1 to the identification unit after an initialization time To defined with respect to the reference event R of the recognition protocol. After receipt of a response datum P1R, the recognition device transmits a transmission datum P2. The time interval T between the transmission of two successive transmission data P1 and P2 is fixed and is greater than the reaction time Tr between the transmission of the transmission datum P1 and the reception of a response datum P1R in such a way as to avoid an overlap between response P1R and transmission P2 data.

FIG. 2b represents versus time the data P1, P2, P3 sent to the identification unit after an outward journey to the pirate relays. This figure depicts the outward journey time Δt1 of the transmission data to the pirate relays.

FIG. 2c represents the time evolution of the response data P1R, P2R, P3R returned by the identification unit to the recognition device after it has been processed. The lag T1 corresponds to the time for processing the transmission datum P1 by the identification unit. This processing time T1 is constant and is known by the recognition device.

FIG. 2d represents the time evolution of the response data P1R, P2R, P3R picked up by the recognition device. The time Δt2 represents the return journey time of the response data in the pirate relays. The time Tr represents the reaction time between the transmission of the transmission datum P1 and the reception of the response datum P1R.

To detect the presence of a pirate relay, the invention disclosed by the document DE 198 02 526 proposes that the reaction time Tr between the transmission of the transmission datum P1 and the reception of the response datum P1R be measured.

When a pirate relay is present in the exchange of data, the reaction time Tr is equal to the addition of the processing time of the identification unit T1 and of the outward and return journey times Δt1, Δt2 in each pirate relay. When this reaction time Tr is greater than a predetermined threshold, the recognition device does not permit the unlocking of the vehicle. Generally, the predetermined threshold is slightly greater than the processing time T1 of the identification unit since the speed of movement of the data is negligible.

However, such a system does not afford a sufficient degree of security. Specifically, to avoid being detected, the pirate relay can during a first exchange of data measure the duration of the initialization time T0, of the time interval T, and possibly the amplitude and frequency characteristics of the data P1, P2, P3. Then during a second exchange of data, the pirate relay can send a datum P1 early, advanced by the time introduced by the journeys of the data in the pirate relays so as to compensate for the lag due to the journey in these relays.

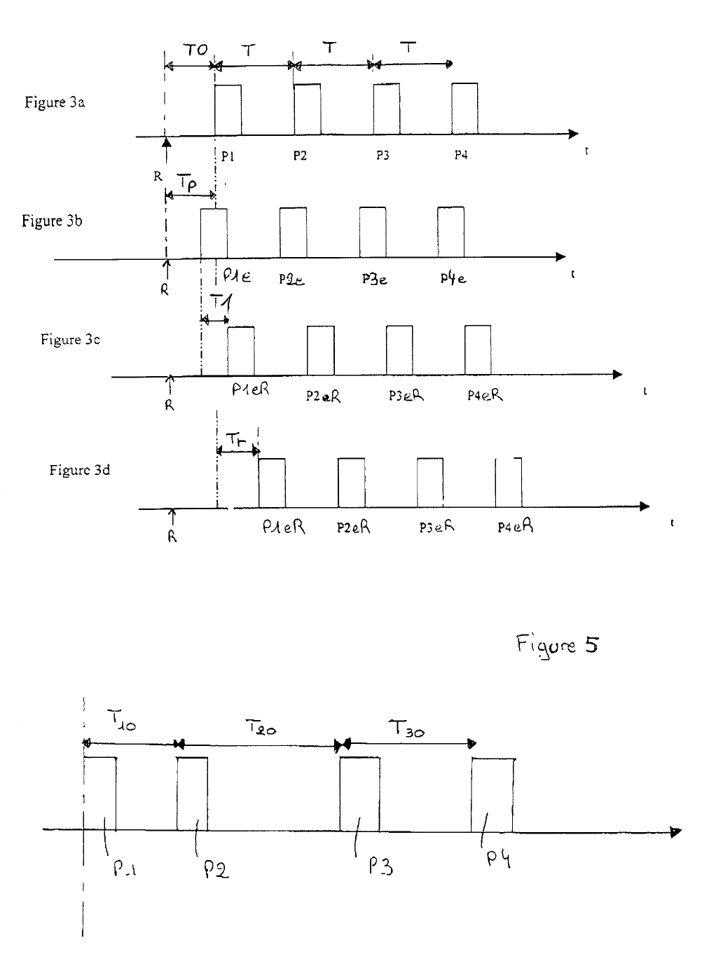

FIGS. 3a to 3d are graphical representations of an exchange of data between a recognition device and an identification unit in the presence of a recorder pirate relay.

In particular, FIG. 3a represents the time evolution of the transmission data P1, P2, P3 transmitted by the recognition device during a first exchange of data.

An exchange of data is defined as an interrogation of the identification unit by the dispatching of the recognition protocol by the recognition device.

During the first exchange of data illustrated in FIG. 3a, a recorder pirate relay captures the transmission data P1, P2, P3 and records the initialization time T0, the time interval T and also possibly the amplitude and frequency characteristics of the data.

During a second exchange of data illustrated in FIG. 3b, the pirate relay triggers the exchange of the data corresponding to the phase of authentication AUT of the identification unit. When this phase has terminated and after a time interval Tp defined with respect to a reference event R, it dispatches a transmission datum P1e which it has recorded during the first exchange of data. The time interval Tp corresponds to the time interval T0 previously recorded less the outward and return journey times Δt1+Δt2 in the pirate relays.

FIG. 3b represents the time evolution of the transmission data P1e, P2e, P3e dispatched by the recorder pirate relay during the second exchange of data.

The advancing of the antipirating phase ANP with respect to the authentication phase AUT is not detected by the identification unit since on the one hand the latter does not know the time interval T0 and since on the other hand unlike the identification code, the pulse P1 is not modified with each exchange of data between the recognition device and the identification unit.

FIG. 3 represents the time evolution of the response data P1eR, P2eR, P3eR returned by the identification unit after they have been processed. The lag T1 corresponds to the time taken to process the response datum P1e by the identification unit.

FIG. 3d represents the time evolution of the response data P1eR received by the recognition device. The reaction time Tr is equal to the processing time T1 of the identification unit. Consequently, the presence of pirate relays can no longer be detected and the so-called <<hands-free>> system is no longer sufficiently secure.

The purpose of the invention is to provide a more reliable security process.

To this end, the subject of the invention is a process for securing a communication between a recognition device and an identification unit able to communicate with the recognition device by a data exchange determined by a recognition protocol, one of these items of data corresponding to a reference event, the process communicating in such a way that the recognition device can authenticate the identification unit so as to instruct the unlocking of openable panels of a vehicle and/or permit the starting of a vehicle and furthermore comprising:

after an initialization time defined with respect to the reference event (R) of the recognition protocol, a step of transmission by the recognition device of at least two transmission data,

a step of transmission by the identification unit of at least two response data in response to the transmission data,

a step of measuring a reaction time between the transmission of a data item and the reception of a corresponding response data item by the recognition device, and a step of verifying that the measured reaction time is less than a predetermined threshold

wherein the time interval between the transmission of two successive transmission data and/or the initialization time are/is made to vary.

The invention will be better understood in the course of the detailed explanatory description which will follow with reference to the figures in which:

FIG. 1 diagrammatically represents an exemplary recognition protocol,

FIGS. 2a to 2d are graphical representations of an exchange of data between the recognition device and the identification unit in the presence of a pirate relay,

FIGS. 3a to 3d are graphical representations of an exchange of data between the recognition device and the identification unit in the presence of a recorder pirate relay,

FIG. 4a represents the time evolution of the data transmitted by a recognition device according to a first embodiment of the present invention during a first exchange of data,

FIG. 4b represents the time evolution of the data transmitted by a recognition device according to a first embodiment of the present invention during a second exchange of data,

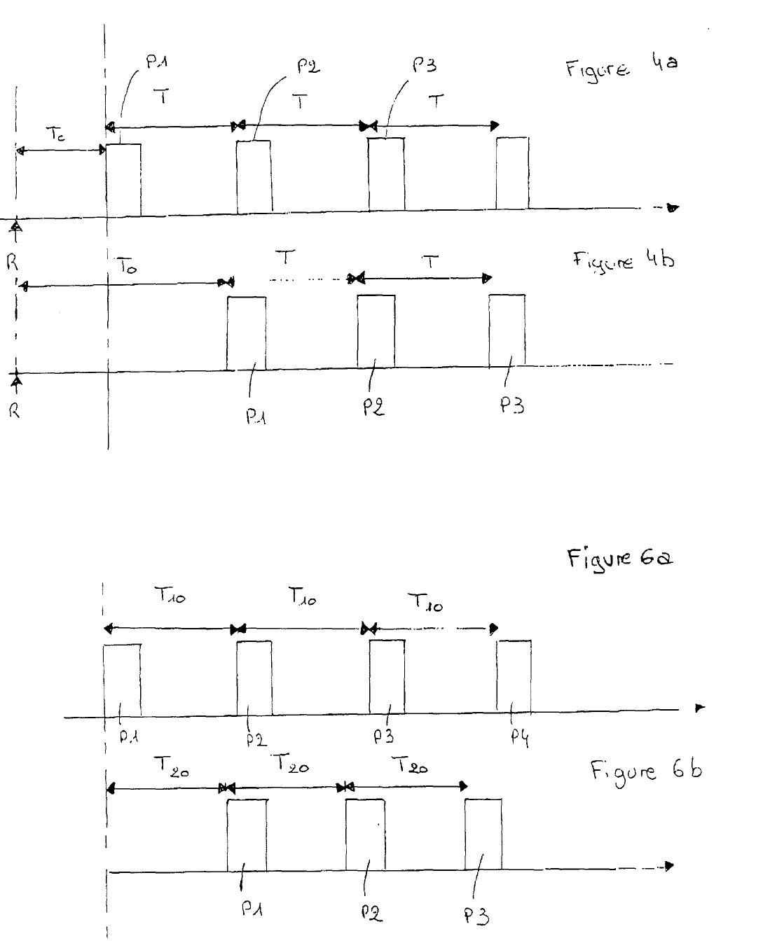

FIG. 5 represents the time evolution of the data transmitted by a recognition device according to a second embodiment of the present invention during an exchange of data,

FIGS. 6a and 6b represent the time evolution of the data transmitted by a recognition device according to a third embodiment of the present invention during an exchange of data.

The security process according to the present invention causes at least one of the characteristic parameters of the transmission data P1, P2, P3 and/or of the response data P1R, P2R, P3R to vary in a random manner with each exchange of data and/or within one and the same exchange of data.

The characteristic parameters of the transmission data P1, P2, P3 and/or of the response data P1R, P2R, P3R are the time interval between two successive data T, the initialization time T0, the frequency of the carrier, the width of the data when the data are transmitted in the form of pulses and the coding of the response data.

Only those embodiments in which the time interval between two successive data T and the initialization time T0 vary have been described in the present description. However, the present invention is in no way limited to these embodiments.

Furthermore, it is possible to vary several characteristic parameters with each exchange of data and/or within one and the same exchange of data.

Moreover, these parameters may vary randomly or according to a predetermined sequence.

According to a first embodiment of the present invention, the initialization time T0 varies with each exchange of data between the recognition device and the identification unit.

FIGS. 4a and 4b represent the time evolution of the transmission data P1, P2, P3 dispatched by the identification unit during a first and a second exchange of data.

The initialization time T0 is defined by the time separating a reference event R of the recognition protocol and the dispatching of the first transmission datum P1 of the antipirating phase ANP (FIG. 3). The reference event R can be defined for example by the end of the wakeup step RE, of the selection step SE or of the response step RP.

According to the present invention, the initialization time T0 varies in a random manner with each exchange of data, the pirate relay can no longer determine the moment at which the datum P1 is dispatched by the recognition device. Consequently, it cannot dispatch a previously recorded transmission datum P1e with an advance corresponding to the lag Δt1+Δt2 introduced by the outward and return journey in the pirate relays.

According to a second embodiment of the present invention, the time interval T between the transmission of two successive data P1 and P2 varies in a random manner within one and the same exchange of data and with each exchange of data. FIG. 5 represents the time evolution of the transmission data P1, P2, P3 dispatched by the identification unit. The recognition device transmits a transmission datum P2 after a time interval T10 and a datum P3 after a time interval T20. The time intervals T10, T20, T30 are random and vary within a predetermined span but they are always greater than the reaction time between the transmission and the reception of a data item so as to avoid overlap between two successive data.

Since the time interval T varies in a random manner within one and the same exchange of data and with each exchange of data, the pirate relay cannot dispatch a datum P1e recorded during a first exchange of data with an advance corresponding to the journey time through a pirate relay since it cannot determine the moment at which a transmission datum P2 will be transmitted.

As a variant, it is possible to vary both the initialization time T0 and the time interval T. The initialization time T0 and the time interval T are characteristic time parameters of the recognition device.

According to a third embodiment of the present invention, the time interval T varies with each exchange of data between the recognition device and the identifying unit. FIGS. 6a and 6b represent the time evolution of the transmission data P1, P2, P3 dispatched by an identification unit. During a first exchange of data (FIG. 6a), the recognition device dispatches transmission data P1, P2, P3, each one separated by a time interval T10. Then, during a second exchange of data (FIG. 6b), the time interval separating two successive data P1 and P2 is different from the time interval T10 and is for example equal to the T20. Thus, it is not possible for the pirate relay to determine in advance the moment at which a data item is transmitted by the recognition device.

Moreover, the recognition device can perform a series of measurements of reaction time between the transmission of several data P1, P2, P3, P4 and the reception of the corresponding data P1R, P2R, P3R and take into consideration only certain measurements. For example, for one hundred reaction times measured in one and the same exchange of data, it would be possible to ignore all but the ninety smallest reaction time bits, so as to discard the abnormal reaction times due to communication glitches. More particularly, in this mode of calculation, one is given a predefined integer number of measured reaction times which will be taken into account. Specifically, the transmission of four data bits may give rise to only three reaction time measurements.

As a variant and/or in combination with the above-described mode of taking bits into account, it is also possible to calculate the average of several reaction time measurements and then to perform a comparison between the average obtained and a predetermined threshold value so as to conclude according to the result which this comparison yields whether the recognition device should or should not permit the unlocking of the vehicle.

1. A process for securing a communication between a recognition device and an identification unit able to communicate with the recognition device by a data exchange determined by a recognition protocol, one of these items of data corresponding to a reference event (R), the process is able to communicate in such a way that the recognition device can authenticate the identification unit so as to instruct the unlocking of openable panels of a vehicle and/or permit the starting of a vehicle and furthermore comprises:
after an initialization time (T0) defined with respect to the reference event (R) of the recognition protocol, a step of transmission by the recognition device of at least two transmission data (P1, P2),
a step of transmission by the identification unit of at least two response data (P1R, P2R) in response to the transmission data (P1, P2),
a step of measuring a reaction time (Tr) between the transmission of a data item (P1) and the reception of a corresponding response data item (P1R) by the recognition device, and a step of verifying that the measured reaction time is less than a predetermined threshold
wherein the time interval (T) between the transmission of two successive transmission data (P1, P2) and/or the initialization time (T0) are/is made to vary randomly.

2. The process as claimed in claim 1, in which at least the time interval (T) between the transmission of two successive transmission data (P1, P2) is made to vary in the course of the same exchange of data between the recognition device and the identification unit.

3. The process as claimed in one of claims 1 or 2, in which the time interval (T) between the transmission of two successive transmission data (P1, P2) and/or the initialization time (T0) are/is made to vary with each exchange of data between the recognition device and the identification unit.

4. The process as claimed in one of claims 1 to 3, furthermore comprising an authentication phase (AUT) comprising in particular a wakeup step (RE), a request step (RQ), an anticollision step (ANT), a selection step (SE) and possibly a response step (RP).

5. The process as claimed in one of claims 1 to 4, in which the step of transmission by the recognition device consists in the transmission of several transmission data (P1, P2, P3) and the step of transmission by the identification unit consists in the transmission of several corresponding response data (P1R, P2R, P3R) and furthermore comprising:
a step of measuring several reaction times (Tr) between the transmission and the reception of several data (P1, P2, P3, P4),
a step of calculating the average of these reaction times,
and a step of comparing the latter with the predetermined threshold so as to authenticate the identification unit.

6. The process as claimed in one of claims 1 to 5, in which the reaction times (Tr) are the n smallest reaction times measured, n being a predefined integer.

7. The process as claimed in one of claims 1 to 5, in which the reference event (R) of the recognition protocol corresponds to the dispatching of a response datum (RP) by the identification unit.

8. The process as claimed in one of claims 1 to 5, in which the reference event (R) of the recognition protocol corresponds to the dispatching of a selection datum (SE) by the recognition device.

9. The process as claimed in one of claims 1 to 5, in which the reference event (R) of the recognition protocol corresponds to the dispatching of a initialization datum (RE) by the recognition device.
